(19) United States
(12) Patent Application Publication
(10) Pub. No.: US 2016/0195759 A1
(43) Pub. Date: Jul. 7, 2016

(54) LIQUID CRYSTAL DISPLAY

(71) Applicant: Samsung Display Co., Ltd., Yongin-City (KR)

(72) Inventors: Sung Hwan WON, Suwon-si (KR); Seong Gyu KWON, Suwon-si (KR)

(21) Appl. No.: 14/736,700

(22) Filed: Jun. 11, 2015

(30) Foreign Application Priority Data
Jan. 7, 2015 (KR) 10-2015-0002076

(51) Int. Cl. G02F 1/1333; G02F 1/1343; G02F 1/1335; G02F 1/1341; G02F 1/1368; G02F 1/1362

(52) U.S. Cl. CPC G02F 1/133377; G02F 1/1368; G02F 1/136286; G02F 1/133512; G02F 1/133514; G02F 1/1341; G02F 1/133345; G02F 1/134309; G02F 2001/133519; G02F 2001/134345

(57) ABSTRACT

A liquid crystal display according to an exemplary embodiment includes: an insulating substrate; gate lines and data lines positioned on the insulating substrate, and crossing each other while being insulated; thin film transistors connected to the gate lines and the data lines; pixel electrodes connected to the thin film transistors; light blocking members positioned on the thin film transistors; a common electrode spaced apart from the pixel electrodes while facing the pixel electrodes; a liquid crystal layer filling microcavities overlapping the pixel electrodes and including liquid crystal molecules; color filters formed on the common electrode; injection holes positioned in the common electrode and the color filters and extending to the microcavities; and an overcoat positioned on the color filters so as to cover the injection holes, in which the light blocking members include protrusion portions positioned so as to overlap the injection holes.

### CROSS-REFERENCE TO RELATED APPLICATION

This application claims priority to and the benefit of Korean Patent Application No. 10-2015-0002076 filed in the Korean Intellectual Property Office on Jan. 7, 2015, the entire contents of which are incorporated herein by reference.

### BACKGROUND

(a) Field

The present application relates to a liquid crystal display.

(b) Description of the Related Art

Currently, display devices are required in widely used computer monitors, televisions, mobile phones, and the like. The display device includes a cathode ray tube display device, a liquid crystal display, a plasma display device, and the like.

A liquid crystal display, which is one of the more common types of flat panel displays currently in use, typically includes two sheets of display panels on which field generating electrodes, such as a pixel electrode and a common electrode, are formed, and a liquid crystal layer interposed therebetween. The liquid crystal display generates electric fields in the liquid crystal layer by applying a voltage to the electric field generating electrodes, and determines an alignment of liquid crystal molecules of the liquid crystal layer by the generated electric field, thus controlling polarization of incident light so as to display images.

The two display panels configuring the liquid crystal display may be formed of a thin film transistor array panel and an opposing display panel. Gate lines transmitting a gate signal and data lines transmitting a data signal, which are formed while crossing each other, a thin film transistor connected to the gate line and the data line, a pixel electrode connected to the thin film transistor, and the like may be formed on the thin film transistor array panel. A light blocking member, a color filter, a common electrode, and the like may be formed in the opposing display panel. If necessary, the light blocking member, the color filter, and the common electrode may also be formed on the thin film transistor array panel.

However, in a liquid crystal display in the related art, two sheets of substrates are used and constituent elements are formed on each of the two substrates, so that there is a problem in that the display device is heavy and thick, cost thereof is high, and a process time is long.

The above information disclosed in this Background section is only for enhancement of understanding of the background and therefore it may contain information that does not form the prior art that is already known in this country to a person of ordinary skill in the art.

### SUMMARY

Embodiments have been made in an effort to provide a display device, which is manufactured by using one substrate, thereby decreasing weight, a thickness, cost, and a process time, and a manufacturing method thereof.

Embodiments have also been made in an effort to prevent performance of a display device from deteriorating due to a poor image quality by controlling a liquid crystal leakage phenomenon incurable in an independent microcavity.

An exemplary embodiment provides a liquid crystal display, including: an insulating substrate; gate lines and data lines positioned on the insulating substrate, and crossing each other while being insulated; thin film transistors connected to the gate lines and the data lines; pixel electrodes connected to the thin film transistors; light blocking members positioned on the thin film transistors; a common electrode spaced apart from the pixel electrodes while facing the pixel electrodes; a liquid crystal layer filling microcavities overlapping the pixel electrodes and including liquid crystal molecules; color filters positioned on the common electrode; injection holes positioned in the common electrode and the color filters and extending to the microcavities; and an overcoat positioned on the color filters so as to cover the injection holes, in which the microcavities are separated based on the pixel electrodes, and the light blocking members include protrusion portions positioned so as to overlap the injection holes.

The pixel electrodes may include first subpixel electrodes and second subpixel electrodes, and the first subpixel electrodes and the second subpixel electrodes may be spaced apart from each other based on the thin film transistors in an extension direction of the data lines.

Pixel areas may include: first subpixel areas overlapping the first subpixel electrodes; and second subpixel areas overlapping the second subpixel electrodes, and the protrusion portions may be positioned in each of the first subpixel areas and the second subpixel areas.

The thin film transistors may be positioned so as to overlap the injection holes.

The number of protrusion portions may be two or more.

The protrusion portions may have different heights.

The protrusion portions may have different lengths with respect to an extension direction of the gate lines.

The number of protrusion portions positioned in the first subpixel areas may be different from the number of protrusion portions positioned in the second subpixel areas.

A height of the protrusion portions may be smaller than or equal to a height of the microcavities.

A height of the light blocking members overlapping the thin film transistors may be larger than a height of the light blocking members which do not overlap the thin film transistors.

A height of the protrusion portions may be the same as a height of the light blocking members overlapping the thin film transistors.

The liquid crystal display may further include: a gate insulating layer positioned on the gate lines; a first passivation layer positioned on the data lines; and an organic insulating layer positioned on the first passivation layer.

The liquid crystal display may further include: a second passivation layer positioned on the common electrode; and a third passivation layer positioned on the color filters, in which the second passivation layer and the third passivation layer are formed of an inorganic material.

According to the exemplary embodiments, the display device is manufactured by using one substrate, thereby decreasing weight, a thickness, cost, and a process time of the display device.

Further, according to the exemplary embodiments, the display device may control a liquid crystal leakage phenomenon for each independent microcavity, thereby decreasing a poor image quality.

### BRIEF DESCRIPTION OF THE DRAWINGS

FIG. 1 is a top plan view of one pixel according to an exemplary embodiment.

FIG. 2 is a cross-sectional view taken along line II-II of FIG. 1.

FIG. 3 is a cross-sectional view taken along line III-III of FIG. 1.

FIGS. 4, 5, and 6 are top plan views of one pixel according to another exemplary embodiment.

FIGS. 7, 8, and 9 are images of one pixel according to the exemplary embodiment.

### DETAILED DESCRIPTION OF THE EMBODIMENTS

The inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

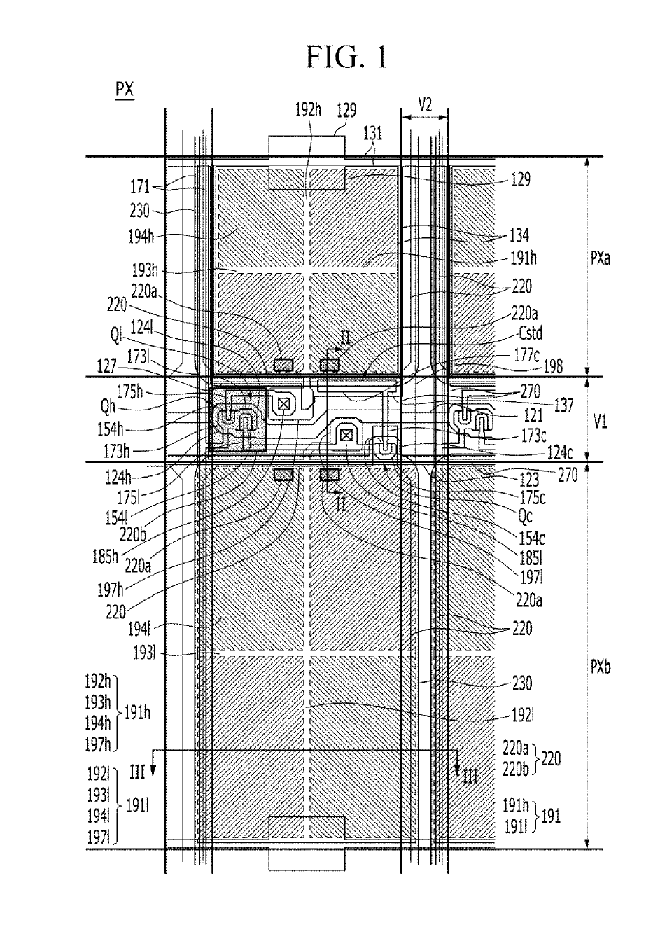

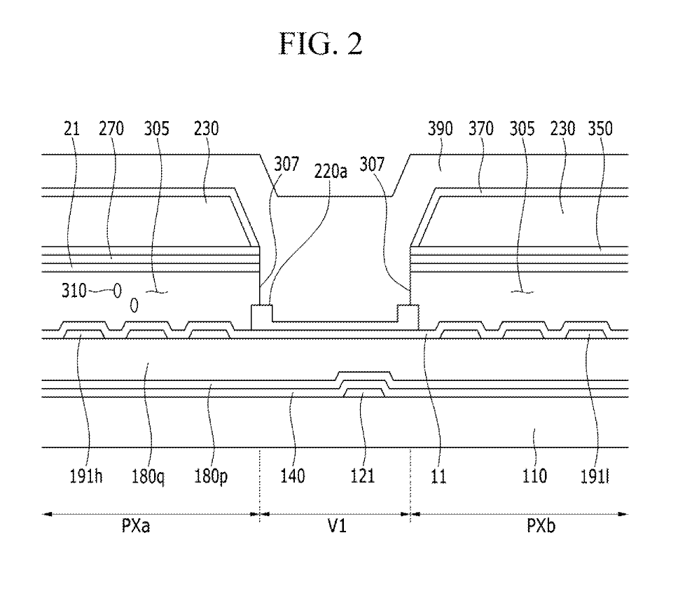

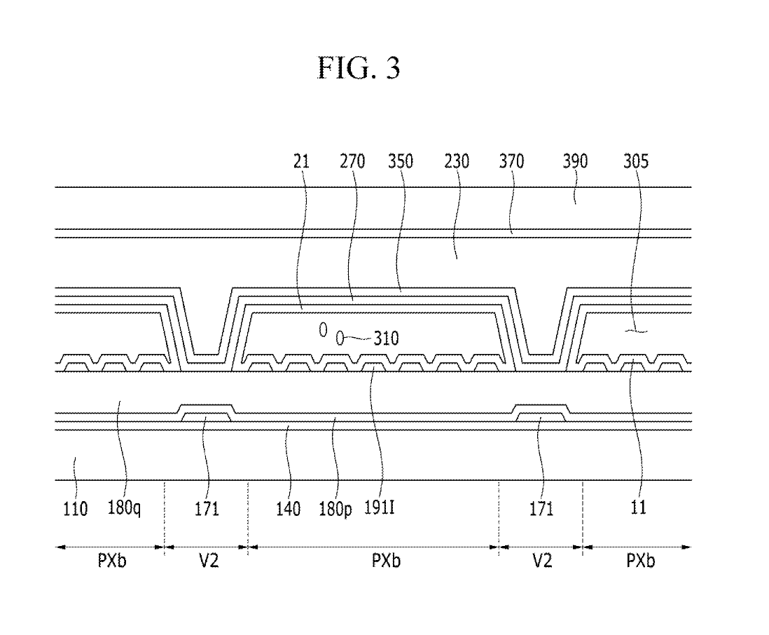

Hereinafter, a liquid crystal display according to an exemplary embodiment will be described with reference to FIGS. 1 to 3. FIG. 1 is a top plan view of one pixel according to an exemplary embodiment, FIG. 2 is a cross-sectional view taken along line II-II of FIG. 1, and FIG. 3 is a cross-sectional view taken along line III-III of FIG. 1.

First, a liquid crystal display according to an exemplary embodiment will be briefly described.

The liquid crystal display according to an exemplary embodiment includes an insulating substrate 110 formed of a material, such as glass, plastic, and the like, and color filters 230 on the insulating substrate 110. The color filter 230 according to the exemplary embodiment performs the same function as that of a roof layer covering a liquid crystal layer.

A plurality of pixel areas PX is positioned on the insulating substrate 110. The plurality of pixel areas PX is disposed in a matrix form including a plurality of pixel rows and a plurality of pixel columns. One pixel area PX is an area overlapping one pixel electrode, and may include, for example, a first subpixel area PXa and a second subpixel area PXb. The first subpixel area PXa overlaps a first subpixel electrode 191h, and the second subpixel area PXb overlaps a second subpixel electrode 191l. The first subpixel area PXa and the second subpixel area PXb may be disposed in a vertical direction that is an extension direction of a data line.

A first valley V1 is positioned between the first subpixel area PXa and the second subpixel area PXb in an extension direction of a gate line, and a second valley V2 is positioned between columns of the adjacent pixel areas PX.

The color filter 230 is formed in the extension direction of the data line. In this case, an injection hole 307 formed by removing the color filter 230 to expose a constituent element positioned under the color filter 230 to the outside is formed in the first valley V1.

Each color filter 230 is spaced apart from the substrate 110 between the adjacent second valleys V2, so that a microcavity 305 is formed. Further, each color filter 230 is formed to be attached to the substrate 110 in the second valley V2 to cover both side surfaces of the microcavity 305.

The aforementioned structure of the display device according to the exemplary embodiment is just an example, and various modifications are feasible. For example, a disposition form of the pixel area PX, the first valley V1, and the second valley V2 may be changed, the plurality of color filters 230 may be connected to each other in the first valley V1, and a portion of each color filter 230 may be formed to be spaced apart from the substrate 110 in the second valley V2 to connect the adjacent microcavities 305 to each other.

Referring to FIG. 1, a plurality of gate conductors including a plurality of gate lines 121, a plurality of step-down gate lines 123, and a plurality of storage electrode lines 131 are positioned on the insulating substrate 110.

The gate line 121 and the step-down gate line 123 are mainly extended in a horizontal direction and transmit a gate signal. The gate conductors further include a first gate electrode 124h and a second gate electrode 124l protruding upwardly and downwardly from the gate line 121, and a third gate electrode 124c protruding upwardly from the step-down gate line 123. The first gate electrode 124h and the second gate electrode 124l are connected to each other to form one protrusion portion. In this case, protrusion forms of the first, second, and third gate electrodes 124h, 124l, and 124c may be changed.

The storage electrode line 131 is also mainly extended in a horizontal direction and transmits a predetermined voltage, such as a common voltage Vcom. The storage electrode line 131 includes a storage electrode 129 which protrudes upwardly and downwardly, a pair of vertical portions 134 which is extended downwardly to be substantially vertical to the gate line 121, and a horizontal portion 127 which connects ends of the pair of vertical portions 134 to each other. The horizontal portion 127 includes a capacitive electrode 137 extended downwardly.

A gate insulating layer 140 is positioned on the gate conductors 121, 123, 124h, 124l, 124c, and 131. The gate insulating layer 140 may be formed of an inorganic insulating material, such as silicon nitride (SiNx) and silicon oxide (SiOx). Further, the gate insulating layer 140 may be formed of a single layer or a multilayer.

A first semiconductor layer 154h, a second semiconductor layer 154l, and a third semiconductor layer 154c are positioned on the gate insulating layer 140. The first semiconductor layer 154h may be positioned on the first gate electrode 124h, the second semiconductor layer 154l may be positioned on the second gate electrode 124l, and the third semiconductor layer 154c may be positioned on the third gate electrode 124c. The first semiconductor layer 154h and the second semiconductor layer 154l may be connected to each other, and the second semiconductor layer 154l and the third semiconductor layer 154c may also be connected to each other. Further, the first semiconductor layer 154h may also be formed to be extended to a lower side of a data line 171. The first to third semiconductor layers 154h, 154l, and 154c may be formed of amorphous silicon, polycrystalline silicon, a metal oxide, or the like.

Ohmic contacts (not illustrated) may be further positioned on the first to third semiconductor layers 154h, 154l, and 154c, respectively. The ohmic contacts may be made of a material, such as n+ hydrogenated amorphous silicon to which silicide or an n-type impurity is doped at a high concentration.

Data conductors including the data line 171, a first source electrode 173h, a second source electrode 173l, a third source electrode 173c, a first drain electrode 175h, a second drain electrode 175l, and a third drain electrode 175c are positioned on the first to third semiconductor layers 154h, 154l, and 154c.

The data line 171 transmits a data signal and is mainly extended in a vertical direction to cross the gate line 121 and the step-down gate line 123. Each data line 171 includes the first source electrode 173h and the second source electrode 173l which are extended toward the first gate electrode 124h and the second gate electrode 124l and connected with each other.

The first drain electrode 175h, the second drain electrode 175l, and the third drain electrode 175c include one wide end portions and the other rod-shaped end portions. The rod-shaped end portions of the first drain electrode 175h and the second drain electrode 175l are partially surrounded by the first source electrode 173h and the second source electrode 173l. The one wide end portion of the second drain electrode 175l is further extended to form the third source electrode 173c which is bent in a U-shape. A wide end portion 177c of the third drain electrode 175c overlaps the capacitive electrode 137 to form a step-down capacitor Cstd and the rod-shaped end portion thereof is partially surrounded by the third source electrode 173c.

The first gate electrode 124h, the first source electrode 173h, and the first drain electrode 175h form a first thin film transistor Qh together with the first semiconductor layer 154h. The second gate electrode 124l, the second source electrode 173l, and the second drain electrode 175l form a second thin film transistor Ql together with the second semiconductor layer 154l. The third gate electrode 124c, the third source electrode 173c, and the third drain electrode 175c form a third thin film transistor Qc together with the third semiconductor layer 154c.

The first semiconductor layer 154h, the second semiconductor layer 154l, and the third semiconductor layer 154c may be connected with each other to be formed in a linear shape, and may have substantially the same planar shape as those of the data conductors 171, 173h, 173l, 173c, 175h, 175l, and 175c and the ohmic contacts therebeneath, except for channel regions between the source electrodes 173h, 173l and 173c and the drain electrodes 175h, 175l, and 175c.

The first semiconductor layer 154h includes a portion which is not hidden by the first source electrode 173h and the first drain electrode 175h and is exposed between the first source electrode 173h and the first drain electrode 175h. The second semiconductor layer 154l includes a portion which is not hidden by the second source electrode 173l and the second drain electrode 175l and is exposed between the second source electrode 173l and the second drain electrode 175l. The third semiconductor layer 154c includes a portion which is not hidden by the third source electrode 173c and the third drain electrode 175e and is exposed between the third source electrode 173c and the third drain electrode 175c.

A first passivation layer 180p is positioned on the data conductors 171, 173h, 173l, 173c, 175h, 175l, and 175c, and the semiconductor layers 154h, 154l, and 154c which are exposed between the source electrodes 173h, 173l, and 173c and the drain electrodes 175h, 175l, and 175c, respectively. The first passivation layer 180p may be formed of an organic insulating material or an inorganic insulating material, and formed of a single layer or a multilayer.

An organic insulating layer 180q may be positioned on the first passivation layer 180p. The organic insulating layer 180q may be formed of an organic insulating material, and includes a contact hole extending to and for exposing the drain electrode.

The first passivation layer 180p and the organic insulating layer 180q are provided with a plurality of first contact holes 185h and a plurality of second contact holes 185l, which extend to and through which the wide end portion of the first drain electrode 175h and the wide end portion of the second drain electrode 175l are exposed, respectively.

A pixel electrode 191 is positioned on the organic insulating layer 180q. The pixel electrode 191 may be formed of a transparent metal material, such as an indium tin oxide (ITO) and an indium zinc oxide (IZO).

The pixel electrode 191 includes the first subpixel electrode 191h and the second subpixel electrode 191l which are separated from each other with the gate line 121 and the step-down gate line 123 interposed therebetween, and disposed on and under the pixel area PX based on the gate line 121 and the step-down gate line 123 to be adjacent to each other in the extension direction of the data line 171. That is, the first subpixel electrode 191h and the second subpixel electrode 191l are separated from each other with the first valley V1 interposed therebetween, and the first subpixel electrode 191h is positioned in the first subpixel area PXa and the second subpixel electrode 191l is positioned in the second subpixel area Pxb.

The first subpixel electrode 191h and the second subpixel electrode 191l are connected with the first drain electrode 175h and the second drain electrode 175l through the first contact hole 185h and the second contact hole 185l, respectively. Accordingly, when the first thin film transistor Qh and the second thin film transistor Ql are in an on-state, the first subpixel electrode 191h and the second subpixel electrode 191l receive a data voltage from the first drain electrode 175h and the second drain electrode 175l.

A general shape of each of the first subpixel electrode 191h and the second subpixel electrode 191l is a quadrangle. Each of the first subpixel electrode 191h and the second subpixel electrode 191l includes cross-shaped stem portions formed by horizontal stem portions 193h and 193l and vertical stem portions 192h and 192l crossing the horizontal stem portions 193h and 193l, respectively. Further, the first subpixel electrode 191h and the second subpixel electrode 191l include a plurality of fine branch portions 194h and 194l and protrusion portions 197h and 197l protruding downwardly or upwardly from border sides of the subpixel electrodes 191h and 191l, respectively.

The pixel electrode 191 is divided into four subareas by the horizontal stem portions 193h and 193l and the vertical stem portions 192h and 192l. The fine branch portions 194h and 194l are obliquely extended from the horizontal stem portions 193h and 193l and the vertical stem portions 192h and 192l, and the extension direction thereof may form an angle of approximately 45° or 135° with respect to the gate line 121 or the horizontal stem portions 193h and 193l. Further, the directions in which the fine branch portions 194h and 194l in the two adjacent subareas are extended may be orthogonal to each other.

In the present exemplary embodiment, the first subpixel electrode 191h further includes an outer peripheral stem portion surrounding an outer peripheral side thereof, and the second subpixel electrode 191l further includes horizontal portions positioned at an upper end and a lower end thereof, and left and right vertical portions 198 positioned at a left side and a right side of the first subpixel electrode 191h. The left and right vertical portions 198 may prevent capacitive coupling, that is, coupling, between the data line 171 and the first subpixel electrode 191h.

The disposition form of the pixel area, the structure of the thin film transistor, and the shape of the pixel electrode, which are described above are just one example, and the embodiments are not limited thereto, and various modifications are feasible.

A light blocking members 220 is positioned in the area in which the thin film transistors Qh, Ql, Qc, are positioned. The light blocking member 220 may be positioned on a boundary portion of the pixel areas PX and the thin film transistors Qh, Ql, Qc to prevent a light leakage. The color filter 230, which is to be described below, may be positioned in each of the first subpixel area PXa and the second subpixel area PXb, and the light blocking member 220 may be positioned between the first subpixel area PXa and the second subpixel area PXb.

The light blocking member 220 is extended upwardly and downwardly while being extended in the extension direction of the gate line 121 and the step-down gate line 123. The light blocking member 220 may cover the areas, in which the first thin film transistor Qh, the second thin film transistor Ql, the third thin film transistor Qc, and the like are positioned, or be extended along the data line 171. That is, the light blocking members 220 may be formed in the first valley V1 and the second valley V2. The color filters 230 and the light blocking members 220 may overlap each other in some areas.

The light blocking member 220 according to the exemplary embodiment includes protrusion portions 220a positioned in the injection hole 307.

The protrusion portion 220a indicates an area of the light blocking member 220, which protrudes in a vertical direction with respect to a plane of the insulating substrate 110, and forms a step in a region in which the protrusion portion 220a is not positioned.

The light blocking member 220 includes the plurality of protrusion portions 220a, and the plurality of protrusion portions 220a is positioned in the first subpixel area PXa and the second subpixel area PXb, respectively. This is because when the plurality of protrusion portions 220a is positioned in one area, the leakage of liquid crystal may be incurred in a microcavity 305 in which the protrusion portion 220a is not positioned.

The plurality of protrusion portions 220a may have different shapes. For example, the plurality of protrusion portions 220a may have different heights. For example, one protrusion portion 220a may be formed to have the same height as that of the microcavity 305, and another protrusion portion 220a may have a height of ⅔ of the height of the microcavity 305. The protrusion portion 220a having the same height as that of the microcavity 305 may meet a first alignment layer 11 and a second alignment layer 21. The protrusion portion 220a is not limited to the aforementioned height, and may have any height smaller or equal to the height of the microcavity 305 as a matter of course.

Further, a light blocking member 220b of the light blocking member 220 overlapping at least one of the thin film transistors, e.g., thin film transistors Qh, Ql, may have a step. That is, the light blocking member 220b positioned in an area overlapping the thin film transistor may have a larger thickness and a larger height than the light blocking member 220 in an area, which does not overlap the thin film transistor. It is possible to effectively prevent light incident into the thin film transistor by the thick light blocking member 220b.

In the meantime, the light blocking member 220b overlapping the thin film transistor and the protrusion portion 220a may be formed by the same process, and for example, when a half-tone mask is used, the light blocking member 220b and the protrusion portion 220a may have the same height. Further, the light blocking member 220b and the protrusion portion 220a are not limited thereto, and the protrusion portions 220a having the different heights and the light blocking member 220b in the area overlapping the thin film transistor may also be formed by using a multi-tone or slit mask.

A common electrode 270 is positioned on the pixel electrode 191 so as to be spaced apart from the pixel electrode 191 by a predetermined distance. The microcavity 305 is formed between the pixel electrode 191 and the common electrode 270. That is, the microcavity 305 is surrounded by the pixel electrode 191 and the common electrode 270. A width and an area of the microcavity 305 may be variously modified according to a size and resolution of the display device.

The common electrode 270 may be formed of a transparent metal material such as an indium tin oxide (ITO) and an indium zinc oxide (IZO). A predetermined voltage may be applied to the common electrode 270, and an electric field may be formed between the pixel electrode 191 and the common electrode 270.

The first alignment layer 11 is formed on the pixel electrode 191. The first alignment layer 11 may also be formed right on the first insulating layer 240 which is not covered by the pixel electrode 191.

The second alignment layer 21 is formed under the common electrode 270 so as to face the first alignment layer 11.

The first alignment layer 11 and the second alignment layer 21 may be formed by a vertical alignment layer, and may be formed of an alignment material, such as polyamic acid, polysiloxane, and polyimide. The first and second alignment layers 11 and 21 may be connected to each other at an edge of the pixel area PX.

A liquid crystal layer formed of liquid crystal molecules 310 is formed within the microcavity 305 positioned between the pixel electrode 191 and the common electrode 270. The liquid crystal molecules 310 may have negative dielectric anisotropy, and may be erected in a vertical direction with respect to the substrate 110 in a state where an electric field is not applied. That is, vertical alignment may be implemented.

The first subpixel electrode 191h and the second subpixel electrode 191l, to which the data voltage is applied, generate electric fields together with the common electrode 270 to determine a direction of the liquid crystal molecules 310 positioned within the microcavity 305 between the two electrodes 191 and 270. Luminance of light passing through the liquid crystal layer is changed according to the direction of the liquid crystal molecules 310 determined as described above.

A second passivation layer 350, sometimes called a second insulating layer 350, is further positioned on the common electrode 270. The second passivation layer 350 may be formed of an inorganic insulating material, such as a silicon nitride (SiNx), a silicon oxide (SiOx), a silicon nitride oxide (SiOxNy), and may be omitted if necessary.

The color filter 230 is positioned on the second passivation layer 350 so as to correspond to each pixel area PX. Each color filter 230 may display any one of the primary colors, such as three primary colors of red, green, and blue. The color filter 230 is not limited to the three primary colors of red, green and blue colors, and may display cyan, magenta, yellow, and white-based colors.

The color filter 230 may be formed of an organic material. The microcavity 305 is formed under the color filter 230, and the color filter 230 may be hardened by a hardening process to maintain the shape of the microcavity 305. That is, the color filer 230 is formed to be spaced apart from the pixel electrode 191 with the microcavity 305 interposed therebetween.

The color filter 230 is formed in each pixel area PX and each second valley V2 in the extension direction of the data line 171 in one pixel area PX, and is not formed in the first valley V1. That is, the color filter 230 is not formed between the first subpixel area PXa and the second subpixel area PXb. The microcavity 305 is formed under each color filter 230 in each first subpixel area PXa and each second subpixel area PXb. The microcavity 305 is not formed under the color filter 230 in the second valley V2, and the color filter 230 is formed to be attached to the substrate 110. Accordingly, a thickness of the color filter 230 positioned in the second valley V2 may be larger than a thickness of the color filter 230 positioned in each first subpixel area PXa and each second subpixel area PXb. An upper surface and both side surfaces of the microcavity 305 have a form covered by the color filter 230.

The color filters 230 adjacent in the extension direction of the gate line 121 may have the same color, and the color filters 230 having the different colors may be repeated in the extension direction of the data line 171. Otherwise, the color filter 230 is not limited thereto, and the color filters 230 having the same color are positioned in the extension direction of the data line 171, and the color filters 230 having the different colors may also be repeated in the extension direction of the gate line 121.

The injection hole 307 extending to and for exposing a part of the microcavity 305 is formed in the common electrode 270, the second passivation layer 350, and the color filter 230. The injection holes 307 may be formed to face each other at edges of the first subpixel area PXa and the second subpixel area PXb. That is, the injection hole 307 may be formed to expose side surfaces of the microcavity 305 while corresponding to a lower side of the first subpixel area PXa and an upper side of the second subpixel area PXb. The microcavity 305 is exposed by the injection hole 307, so that an alignment liquid, a liquid crystal material, or the like may be injected into the microcavity 305 through the injection hole 307.

In the meantime, according to the exemplary embodiment, the protrusion portion 220a is positioned in the injection hole 307 of the microcavity 305. According to the protrusion portion 220a, it is possible to prevent the liquid crystal layer injected into the microcavity 305 from flowing out again. Accordingly, the liquid crystal layer is completely injected into the microcavity 305, and thus, it is possible to provide a display device with an improved quality.

A third passivation layer 370, sometimes called a third insulating layer 370, is positioned on the color filter 230. The third passivation layer 370 may be formed of the same material as that of the second passivation layer 350.

An overcoat 390 is positioned on the third passivation layer 370. The overcoat 390 covers the injection hole 307 through which a part of the microcavity 305 is exposed to the outside. That is, the overcoat 390 seals the microcavity 305 so as to prevent the liquid crystal molecules 310 positioned inside the microcavity 305 from flowing out to the outside. Since the overcoat 390 is in contact with the liquid crystal molecules 310, the overcoat 390 may be formed of a material that is not reacted with the liquid crystal molecules 310. For example, the overcoat 390 may be formed of parylene or the like.

The overcoat 390 may be formed of a multilayer, such as a double layer or a triple layer. The double layer is formed of two layers formed of different materials. The triple layer is formed of three layers, and materials of the adjacent layers are different from each other. For example, the overcoat 390 may include a layer formed of an organic insulating material and a layer formed of an inorganic insulating material.

Although not illustrated in the drawings, a polarizer may be further formed on upper and lower surfaces of the display device. The polarizer may include a first polarizer and a second polarizer. The first polarizer may be attached onto a lower surface of the substrate 110, and the second polarizer may be attached onto the overcoat 390.

According to the aforementioned display device, it is possible to prevent the injected liquid crystal layer from flowing out to the outside again through the protrusion portion 220a, sometimes called a protrusion, positioned in the injection hole 307. Accordingly, it is possible to provide a display device with a more improved display quality.

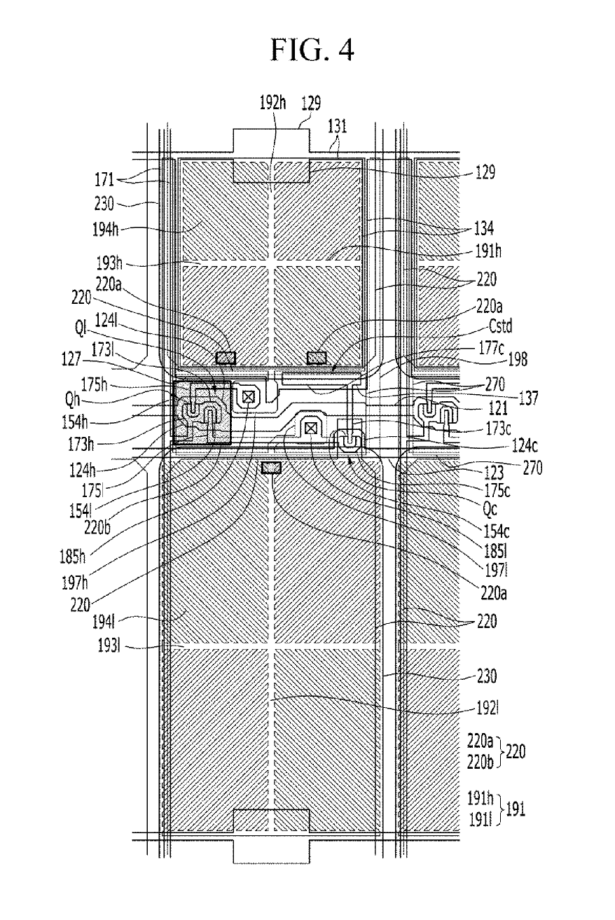

A liquid crystal display according to another exemplary embodiment will be described. FIGS. 4 to 6 are top plan views of one pixel according to other exemplary embodiments. Descriptions of the identical or similar constituent element to those of the aforementioned exemplary embodiment will be omitted.

First, referring to FIG. 4, the number of protrusion portions 220a positioned in a first subpixel area PXa may be different from the number of protrusion portions 220a positioned in a second subpixel area PXb. Two protrusion portions 220a may be positioned in the first subpixel area PXa and one protrusion portion 220a may be positioned in the second subpixel area PXb. The aforementioned number is an example for description, and the number of protrusion portions 220a is not limited thereto as a matter of course.

That is, the protrusion portion 220a prevents the injected liquid crystal from flowing out by controlling capillary force inside the microcavity 305, and the number of protrusion portions 220a is not limited.

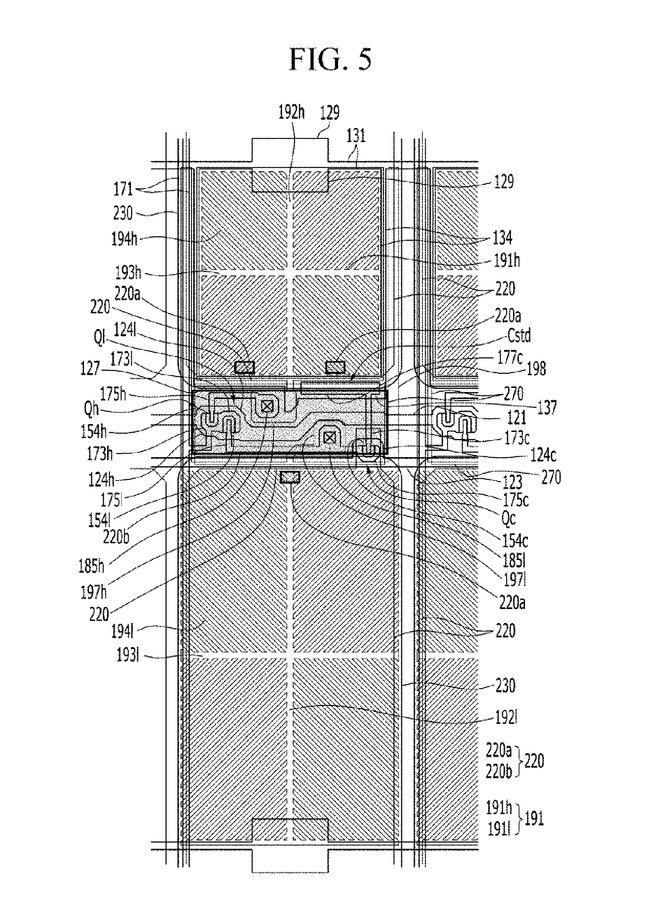

Next, referring to FIG. 5, the numbers of protrusion portions 220a positioned in a first subpixel area PXa and a second subpixel area PXb may be different from each other, and a light blocking member 220 for the entire area in which a thin film transistor is positioned may be formed to be thick.

Particularly, in the exemplary embodiment illustrated in FIG. 4, a light blocking member 220b is thickly formed for an area in which thin film transistors Qh, Ql are positioned, but in the exemplary embodiment illustrated in FIG. 5, the light blocking member 220b may be generally thickly formed for areas within one pixel area in which the first subpixel electrode 191h and the second subpixel electrode 191l are not positioned. This is to control the flow out of the liquid crystal layer injected into the microcavity 305, and protect the area of the thin film transistors.

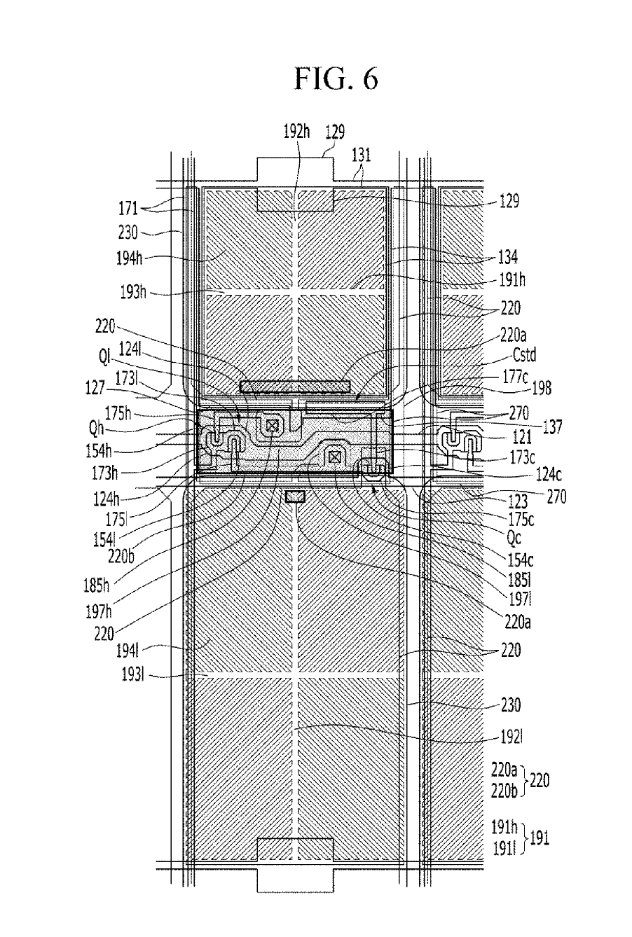

Next, referring to FIG. 6, a plurality of protrusion portions 220a may have different lengths with respect to an extension direction of a gate line 121. This represents that as illustrated in FIG. 6, the protrusion portion 220a positioned in the first subpixel area PXa is elongated in the extension direction of the gate line 121, and the protrusion portion 220a positioned in the second subpixel area PXb is formed to be short in the extension direction of the gate line 121, so that a plane shape of the protrusion portion 220a may almost be a square.

That is, the plurality of protrusion portions 220a may have different shapes, and different lengths with respect to the extension direction of the gate line 121. Some of the protrusion portions 220a may be formed to be short, and the other protrusion portions 220a may be formed to be long. The long protrusion portion 220a may be the same as a plurality of short protrusion portions 220a which are formed in parallel.

The characteristics of the light blocking members according to other exemplary embodiments have been described, but the inventive concept may be carried out by combining the characteristics as a matter of course.

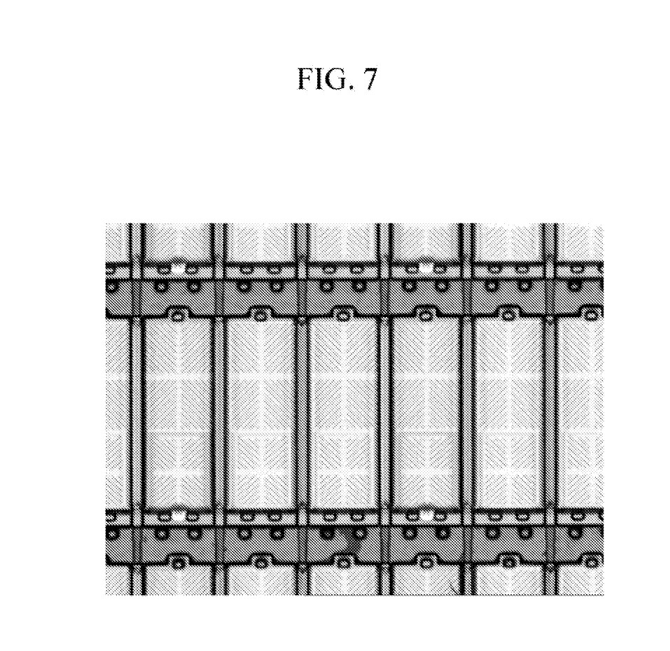

Hereinafter, control of a liquid crystal leakage phenomenon of the liquid crystal display according to the exemplary embodiment will be described. FIGS. 7 to 9 are images of one pixel according to the exemplary embodiment.

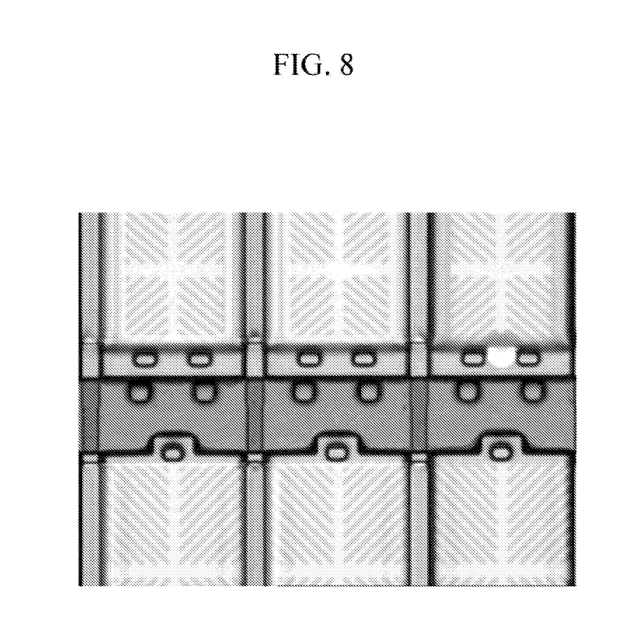

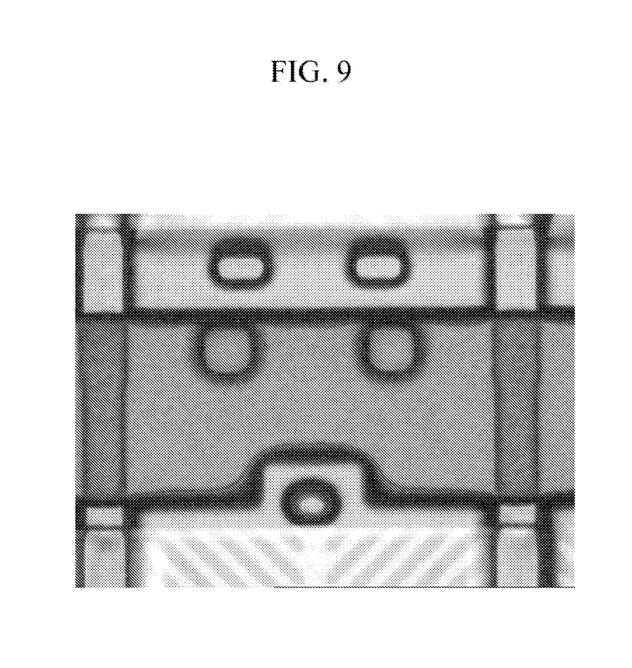

As illustrated in FIGS. 7 to 9, according to an exemplary embodiment, it can be seen that a liquid crystal leakage phenomenon is not incurred in the general pixel area. Particularly, as illustrated in FIGS. 8 and 9, as a result of thorough investigating the injection hole of the liquid crystal layer, it can be seen that the liquid crystal layer is injected into a boundary of the microcavity. Accordingly, the liquid crystal display according to the exemplary embodiment may provide an improved quality by controlling a liquid crystal leakage phenomenon incurred in each microcavity.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

### DESCRIPTION OF SYMBOLS

| | |
|---|---|
| 11: First alignment layer | 21: Second alignment layer |
| 110: Insulating substrate | 121: Gate line |
| 124h: First gate electrode | 124l: Second gate electrode |
| 124c: Third gate electrode | 131: Storage electrode line |
| 140: Gate insulating layer | 171: Data line |
| 191: Pixel electrode | 191h: First subpixel electrode |
| 191l: Second subpixel electrode | 220: Light blocking member |
| 230: Color filter | |
| 270: Common electrode | 305: Microcavity |
| 307: Injection hole | |
| 310: Liquid crystal molecule | 350: Second insulating layer |
| 370: Third insulating layer | 390: Overcoat |

What is claimed is:

1. A liquid crystal display, comprising:
an insulating substrate;
gate lines and data lines positioned on the insulating substrate, and crossing each other while being insulated;
thin film transistors connected to the gate lines and the data lines;
pixel electrodes connected to the thin film transistors;
light blocking members positioned on the thin film transistors;
a common electrode spaced apart from the pixel electrodes while facing the pixel electrodes;
a liquid crystal layer filling microcavities overlapping the pixel electrodes and including liquid crystal molecules;
color filters positioned on the common electrode;
injection holes positioned in the common electrode and the color filters and extending to the microcavities; and
an overcoat positioned on the color filters so as to cover the injection holes,
wherein the microcavities are separated based on the pixel electrodes, and the light blocking members include protrusion portions positioned so as to overlap the injection holes.

2. The liquid crystal display of claim 1, wherein:
the pixel electrodes includes first subpixel electrodes and second subpixel electrodes, and
the first subpixel electrodes and the second subpixel electrodes are spaced apart from each other based on the thin film transistors in an extension direction of the data lines.

3. The liquid crystal display of claim 2, wherein:
pixel areas includes:
first subpixel areas overlapping the first subpixel electrodes; and
second subpixel areas overlapping the second subpixel electrodes, and
the protrusion portions are positioned in each of the first subpixel areas and the second subpixel areas.

4. The liquid crystal display of claim 1, wherein:
the thin film transistors are positioned so as to overlap the injection holes.

5. The liquid crystal display of claim 3, wherein:
the number of protrusion portions is two or more.

6. The liquid crystal display of claim 5, wherein:
the protrusion portions have different heights.

7. The liquid crystal display of claim 5, wherein:
the protrusion portions have different lengths with respect to an extension direction of the gate lines.

8. The liquid crystal display of claim 5, wherein:
the number of protrusion portions positioned in the first subpixel areas is different from the number of protrusion portions positioned in the second subpixel areas.

9. The liquid crystal display of claim 5, wherein:
a height of the protrusion portions is smaller than or equal to a height of the microcavities.

10. The liquid crystal display of claim 5, wherein:
a height of the light blocking members overlapping the thin film transistors is larger than a height of the light blocking members which do not overlap the thin film transistors.

11. The liquid crystal display of claim 10, wherein:
a height of the protrusion portions is the same as a height of the light blocking members overlapping the thin film transistors.

12. The liquid crystal display of claim 1, further comprising:
a gate insulating layer positioned on the gate lines;
a first passivation layer positioned on the data lines; and
an organic insulating layer positioned on the first passivation layer.

13. The liquid crystal display of claim 1, further comprising:
a second passivation layer positioned on the common electrode; and
a third passivation layer positioned on the color filters,
wherein the second passivation layer and the third passivation layer are formed of an inorganic material.
